(19) United States
(12) Patent Application Publication
(10) Pub. No.: US 2012/0176326 A1
(43) Pub. Date: Jul. 12, 2012

(54) CONTROL DEVICE FOR TOUCH PANEL AND SIGNAL PROCESSING METHOD THEREOF

(75) Inventors: Wei Fen Lin, Zhubei City (TW); Yong Nien Rao, Hsinchu City (TW); Shang Ping Tang, Hsinchu City (TW)

(73) Assignee: Raydium Semiconductor Corporation, Hsinchu (TW)

(21) Appl. No.: 13/338,552

(22) Filed: Dec. 28, 2011

(30) Foreign Application Priority Data
Jan. 7, 2011 (TW) 100100582

(51) Int. Cl. G06F 3/041

(52) U.S. Cl. 345/173

(57) ABSTRACT

The present invention discloses a control device for a touch panel. The touch panel comprises a plurality of X-directional sensing lines and a plurality of Y-directional sensing lines arranged in a staggered manner. The control device comprises a clock generation circuit, a selection module, an analog to digital conversion circuit, and a control unit. The selection module selects sensing lines to be measured from the X-directional sensing lines and Y-directional sensing lines. The control unit controls the operation mode of the analog to digital conversion circuit. The analog to digital conversion circuit outputs an n-bit digital signal when it operates in a normal mode, and outputs an m-bit digital signal when it operates in a detecting mode, wherein n>m. According to the control device of the present invention, valid data is output in the presence of noise.

### BACKGROUND OF THE INVENTION

1. Field of the Invention The present invention relates to a control device for a touch panel and a signal processing method thereof.

2. Description of the Related Art

Touch panels are widely applied in a variety of fields such as home appliances, communication devices and electronic information devices. The touch panel is often applied in input interfaces of personal digital assistants (PDAs), electronic products and game consoles. The current trend of integrating a touch panel and a display allows a user to select an icon displayed on the panel by using a finger or a touch pen, so that the PDA, the electronic product, or the game console executes a desired is function. The touch panel may also be applied in a public information inquiry system, so that the user can operate the system more efficiently.

FIG. 1 is a schematic view of a conventional touch input device 10. The touch input device 10 includes a touch panel 12 and a control device 100. The touch panel 12 includes a plurality of X-directional sensing lines X1 to Xm, and a plurality of Y-directional sensing lines Y1 to Yn. Referring to FIG. 1, the plurality of X-directional sensing lines X1 to Xm and the plurality of Y-directional sensing lines Y1 to Yn are arranged in a staggered manner. A plurality of rhombus grids 11 are disposed between the X-directional sensing lines X1 to Xm and the Y-directional sensing lines Y1 to Yn. When a touching tool such as a finger or a touch pen contacts the touch panel 12, the capacitive value between rhombus grids 11 in the panel and the touching tool will be changed due to the touching tool.

The control device 100 includes a selection module 14, an analog to digital conversion circuit 16, and a processing unit 18. The selection module 24 couples with the touch panel 12 and selects the sensing lines L1 to Ln from the X-directional sensing lines X1 to Xm and the Y-directional sensing lines Y1 to Yn. The analog to digital conversion circuit 16 converts the voltages of the sensing lines L1 to Ln to an n-bit digital signal. The n-bit digital signal represents the touching condition of the sensing lines to be measured. The processing unit 18 receives the n-bit digital signal converted by the analog to digital conversion circuit 16 and figures out the touching condition of the sensing lines through an algorithm. The touching condition includes data of the touching position and the touching area of the touching tool.

However, the signal received by the processing unit 18 may be a clear touching signal or a signal with noise. Thus, the processing unit 18 requires a complex filter for removing the noise. In order to simplify the is internal circuitry of the processing unit 18 and to provide an efficient digital signal, it is necessary to provide a control device for a touch panel and a signal processing method thereof to filter the noise from the output data.

### SUMMARY OF THE INVENTION

The present invention discloses a control device for a touch panel. The touch panel comprises a plurality of X-directional sensing lines and a plurality of Y-directional sensing lines. The X-directional sensing lines and the Y-directional sensing lines are arranged in a staggered manner. The control device of the present invention comprises a selection module, an analog to digital conversion circuit, and a control unit. The selection module selects the sensing lines to be measured from the X-directional sensing lines and the Y-directional sensing lines. The analog to digital conversion circuit couples with the selection module for receiving voltages of the sensing lines to be measured. In accordance with different operation modes, the analog to digital conversion circuit converts the voltages into different bits of a sequence digital signal. When the analog to digital conversion circuit operates in a normal mode, the analog to digital conversion circuit outputs an n-bit digital signal. When the analog to digital conversion circuit operates in a detecting mode, the analog to digital conversion circuit outputs an m-bit digital signal, wherein n>m. The control unit is configured for controlling the analog to digital conversion circuit to operate either in the normal mode or in the detecting mode.

The present invention also discloses a signal processing method for a touch panel. The signal processing method of the present invention comprises the following steps: selecting a plurality of sensing lines to be measured from the X-directional sensing lines and the Y-directional sensing lines; determining a threshold value and a bit number m to be measured; converting voltages of the sensing lines to be measured in accordance with the m-bit and outputting an m-bit digital signal; detecting the converted m-bit digital signal and a difference between the m-bit digital is signal and a predetermined m-bit digital signal, when the converted m-bit digital signal and the predetermined m-bit digital signal have the same value to accumulate a counting value; and converting voltages of the sensing lines to be measured to an n-bit digital signal when the counting value is greater than or equal to the threshold value, wherein n>m.

The foregoing has outlined rather broadly the features and technical benefits of the disclosure in order that the detailed description of the invention that follows may be better understood. Additional features and benefits of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes of the disclosure. It should also be realized by those skilled in the art that such equivalent constructions do not depart from the spirit and scope of the invention as set forth in the appended claims.

### BRIEF DESCRIPTION OF THE DRAWINGS

The invention will be described according to the appended drawings in which:

FIG. 1 is a schematic view of a conventional touch input device;

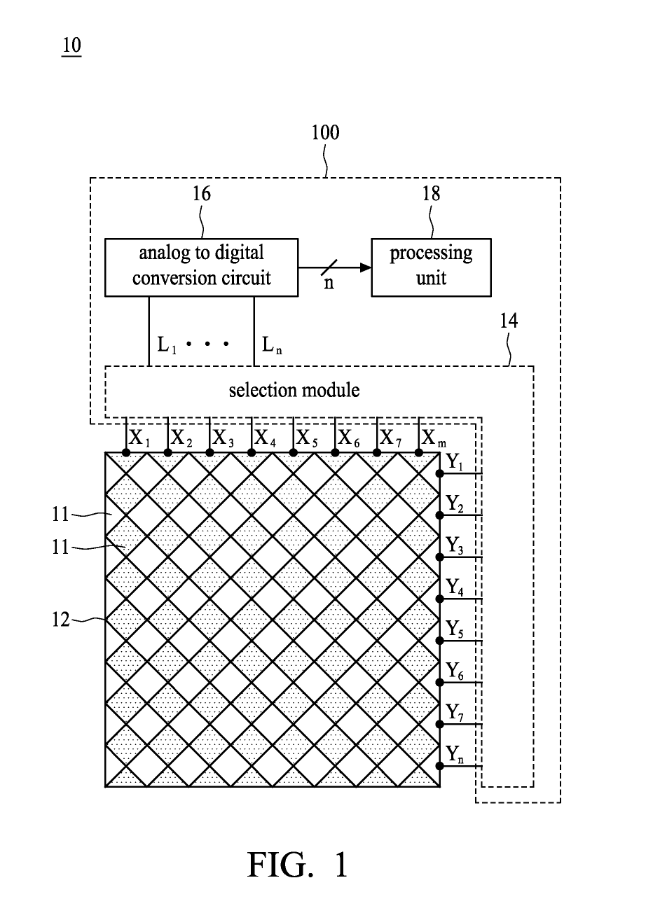

FIG. 2 is a schematic view of a touch input device in accordance with one embodiment of the present invention;

FIG. 3 is a schematic block diagram of a detail circuit of the control unit in accordance with one embodiment of the present invention;

FIG. 4 is a schematic view of another touch input device in accordance with one embodiment of the present invention; and

FIG. 5 is a schematic view of an operation mode of the touch input device in accordance with one embodiment of the present invention.

### DETAILED DESCRIPTION OF THE INVENTION

The present invention is directed to a control device and a signal is processing method for a touch panel. In order to make the present invention completely comprehensible, detailed steps and structures are provided in the following description. Obviously, implementation of the present invention does not limit special details known by persons skilled in the art. In addition, known structures and steps are not described in detail, so as not to unnecessarily limit the present invention. Preferred embodiments of the present invention will be described below in detail. However, in addition to the detailed description, the present invention may also be widely implemented in other embodiments. The scope of the present invention is not limited to the detailed description, and is defined by the claims.

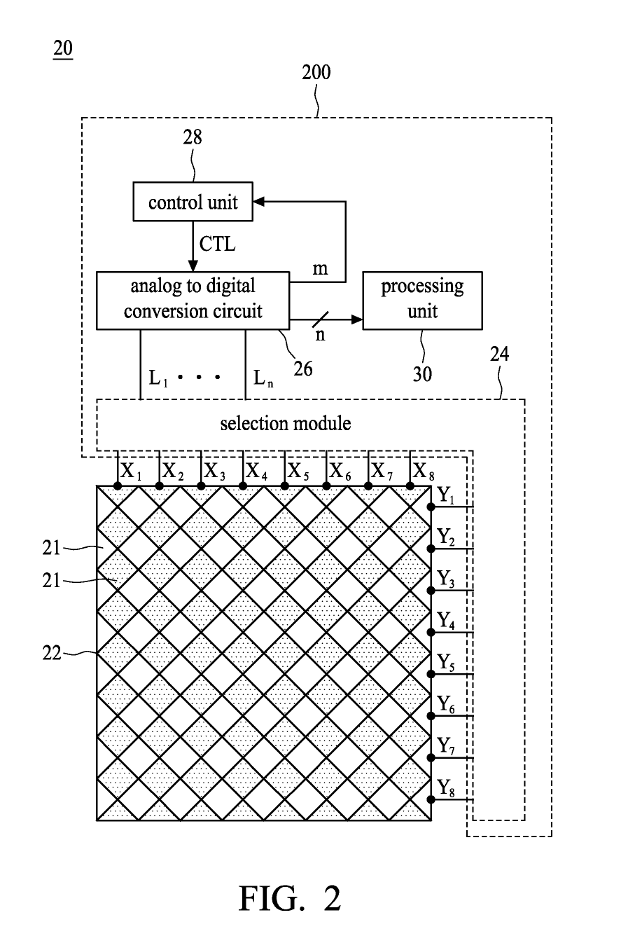

FIG. 2 illustrates a schematic view of a touch input device 20 in accordance with an embodiment of the present invention. The touch input device 20 comprises a touch panel 22 and a control device 200. The control device 200 is configured for providing a driving signal to the touch panel 22 and detecting its touch condition. The touch panel 22 comprises a plurality of X-directional sensing lines X₁ to X₈ and a plurality of Y-directional sensing lines Y₁ to Y₈. Referring to FIG. 2, the X-directional sensing lines X₁ to X₈ and the Y-directional sensing lines Y₁ to Y₈ are arranged in a staggered manner. A plurality of rhombus grids 21 are disposed between the X-directional sensing lines X₁ to X₈ and the Y-directional sensing lines Y₁ to Y₈. When every grid on the X-directional sensing lines X₁ to X₈ and the Y-directional sensing lines Y₁ to Y₈ is electrically conducted, a touching tool such as a finger or a touch pen contacts the touch panel 22 such that the capacitive value between rhombus grids 21 in the panel and the touching tool will be changed due to the touching tool.

is Referring FIG. 2, the control device 200 includes a selection module 24, an analog to digital conversion circuit 26, a control unit 28, and a control unit 30. The selection module 24 couples with the touch panel 22. During touch detection of the touch panel 22, the driving signals will be applied to the X-directional sensing lines X₁ to X₈ and the Y-directional sensing lines Y₁ to Y₈. The selection module 24 selects a plurality of sensing lines L₁ to Lₙ to be measured from the X-directional sensing lines X₁ to X₈ and the Y-directional sensing lines Y₁ to Y₈ for detecting the capacitive variation of the sensing lines.

As shown in FIG. 2, the analog to digital conversion circuit 26 couples with the selection module 24. The analog to digital conversion circuit 26 receives the voltages of the sensing lines L₁ to Lₙ to be measured and converts the voltages into different bits of a sequence digital signal in accordance with different operation modes. The analog to digital conversion circuit 26 of an embodiment of the present invention can include a successive approximation register (SAR) (not shown). The SAR controls the analog to digital conversion circuit 26 bit by bit to output in accordance with a binary search algorithm. The analog to digital conversion circuit 26 can be operated either in a normal mode or a detecting mode. When the analog to digital conversion circuit 26 operates in a normal mode, the analog to digital conversion circuit 26 outputs an n-bit digital signal to the processing unit 30. When the analog to digital conversion circuit 26 operates in a detecting mode, the analog to digital conversion circuit 26 outputs an m-bit digital signal to the control unit 28. The bit number of the m-bit digital signal is smaller than the bit number of the n-bit digital signal.

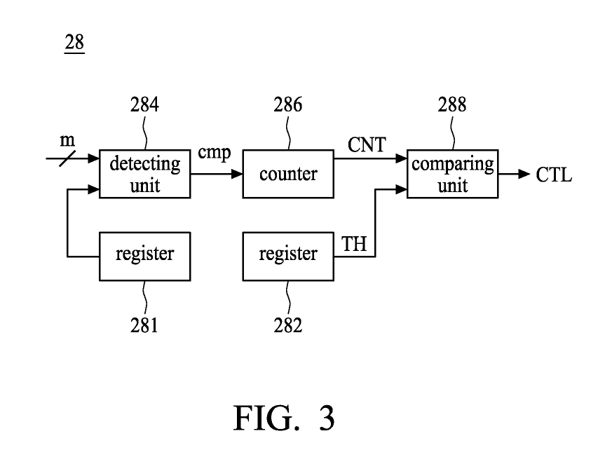

The operation mode of the analog to digital conversion circuit 26 is controlled by a control unit 28. FIG. 3 illustrates a detail circuit of the control unit 28 in accordance with an embodiment of the present invention. Referring to FIG. 3, the control unit 28 includes registers 281, 282, a detecting unit 284, a counter 286 and a comparing unit 288. The first is register 281 is configured for recording a predetermined m-bit digital signal. The second register 282 is configured for recording a threshold value (TH). The detecting unit 284 is configured for detecting the m-bit digital signal converted by the analog to digital conversion circuit 26 in the detecting mode and comparing the m-bit digital signal to be measured with the predetermined m-bit digital signal to generate a comparing signal (cmp). The counter 286 is coupled with the detecting unit 284 and configured for accumulating a counting value (CNT) in accordance with the comparing signal cmp. The comparing unit 288 is coupled with the counter 286 and configured for comparing the counting value (CNT) and the threshold (TH). When the counting value (CNT) is greater than or equal to the threshold (TH), the comparing unit 286 transmits a control signal (CTL) to control the analog to digital conversion circuit 26 to operate in the normal mode.

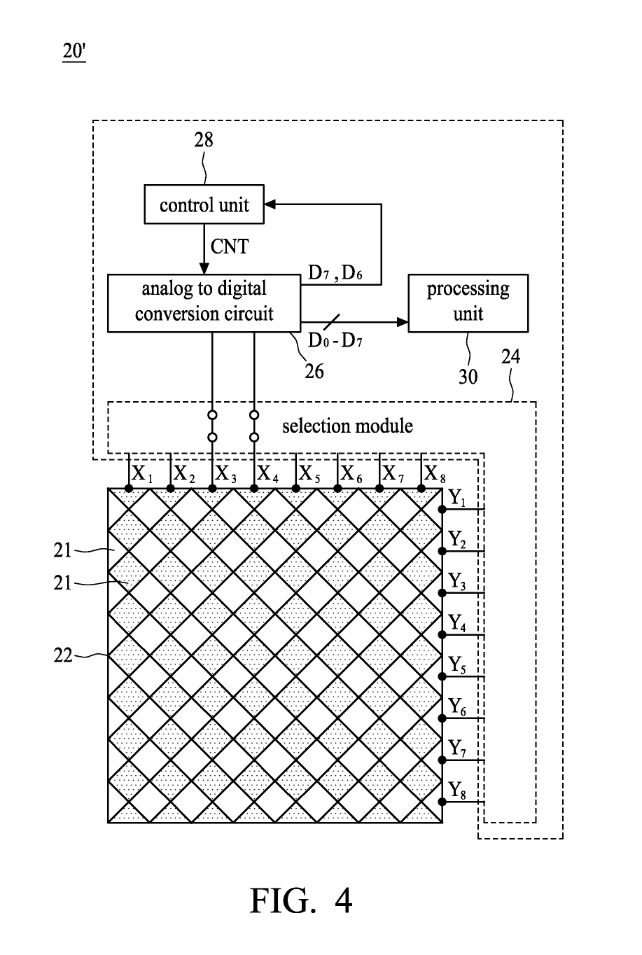

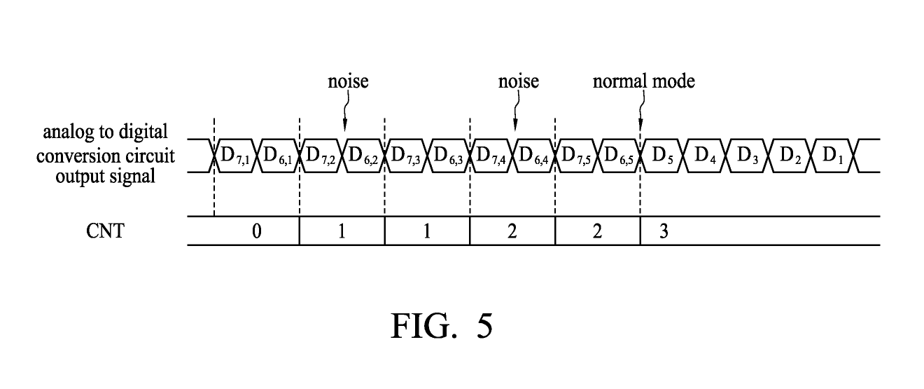

In one embodiment of the present invention, the touch input device 20 is operated as illustrated in FIG. 4 and FIG. 5. Referring to FIG. 4, during the first scan in a touch panel, if the selection module 24 selects sensing lines X₃ and X₄ to be measured from the X-directional sensing lines X₁ to X₈, the analog to digital conversion circuit 26 will convert the voltages of the sensing lines X₃ and X₄ to generate an 8-bit digital signal D₀ to D₇. Dₒ is the least significant bit (LSB) and D₇ is the most significant bit (MSB). However, the 8-bit digital signal may be a clear touching signal or a signal with noise. In order to avoid unnecessary processing by the processing unit 30 for the capacitive variation due to the noise, the analog to digital conversion circuit 26 is initially operated in a detecting mode to output 2-bit digital signals D_{7,1} and D_{6,1}. The analog to digital conversion circuit 26 of the present embodiment can output, but is not limited to outputting, the 2-bit digital signals. In other words, when the analog to digital conversion circuit 26 is operated in the detecting mode, the bit number outputted by the analog to digital conversion circuit 26 can be predetermined in accordance with different designs and is not limited to the MSB digital signals.

is In the present embodiment, the 2-bit digital signals D_{7,1} and D_{6,1} will be recorded in the first register 281. Consequently, the analog to digital conversion circuit 26 continuously converts the voltages of the sensing lines X₃ and X₄ to 2-bit digital signals D _{7, 2} and D _{6, 2} . Since the noise interferes with the signal, the value of the digital signals D_{7,2} and D_{6,2} is different from that of the digital signals D_{7,1} and D_{6,1}. Thus, after the detecting unit 282 compares the digital signals D_{7,2} and D_{6,2} with digital signals D_{7 ,1} and D ₆ , ₁ , the detecting unit 282 will generate a comparing signal (cmp) with a low level. The counter 286 is not activated in accordance with the low-level comparing signal (cmp).

The analog to digital conversion circuit 26 continuously converts the voltages of the sensing lines X₃ and X₄ to 2-bit digital signals D_{7,3} and D _{6,3}. Since the value of the digital signals D_{7,3} and D_{6,3} is the same as that of the digital signals D_{7,1} and D_{6,1}, the detecting unit 282 will generate a comparing signal (cmp) with a high level. The counter 286 will accumulate a counting value in accordance with the high-level comparing signal (cmp).

Similarly, the analog to digital conversion circuit 26 continuously converts the voltages of the sensing lines X₃ and X₄. After the detecting unit 282 compares the converted digital signals with the digital signals D_{7,1} and D_{6,1}, the level of the comparing signal (cmp) is continuously updated. The comparing unit 288 determines whether the counting value (CNT) is accumulated in accordance with the level of the comparing signal (cmp). When the counting value (CNT) is greater than or equal to the threshold value (e.g. 3) registered by the second register 282, the comparing D) unit 286 transmits a control signal (CTL) to switch the analog to digital conversion circuit 26 to operate in the normal mode from the detecting mode. Therefore, the analog to digital conversion circuit 26 will continuously convert the voltages of the sensing lines X ₃ and X₄ to a 2-bit digital signal. The entire 8-bit digital signal D₀ to D₇ will be transmitted is to the processing unit 30 for further processing. Since the control device 200 of the present invention can adjust the outputted bit number of the analog to digital conversion circuit 26 and the threshold value, the present invention can effectively remove the noise and ensure the signals received by the processing unit 30 to be clear touch signals.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A control device for a touch panel, wherein the touch panel comprises a plurality of X-directional sensing lines and a plurality of Y-directional sensing lines, the X-directional sensing lines and the Y-directional sensing lines are arranged in a staggered manner, and the control device comprising:
a selection module, selects a plurality of sensing lines to be measured from the X-directional sensing lines and the Y-directional sensing lines;
an analog to digital conversion circuit, coupled with the selection module for receiving voltages of the sensing lines to be measured, wherein the analog to digital conversion circuit converts the voltages into different bits of a sequence digital signal, when the analog to digital conversion circuit operates in a normal mode, the analog to digital conversion circuit outputs a n-bit digital signal, when the analog to digital conversion circuit is operates in a detecting mode, the analog to digital conversion circuit outputs a m-bit digital signal, and n>m; and
a control unit, configured for controlling the analog to digital conversion circuit to operate either in the normal mode or in the detecting mode.

2. The control device according to claim 1, wherein the control unit includes:
a first register, configured for recording a predetermined m-bit digital signal;
a second register, configured for recording a threshold value;
a detecting unit, configured for detecting the m-bit digital signal converted by the analog to digital conversion circuit and comparing the m-bit digital signal to be measured with the predetermined m-bit digital signal to generate a comparing signal;
a counter, configured for accumulating a counting value; and
a comparing unit, configured for comparing the counting value and the threshold, wherein when the counting value is greater than or equal to the threshold, the comparing unit controls the analog to digital conversion circuit to operate in the normal mode.

3. The control device according to claim 1, further comprising a processing unit, configured for receiving the n-bit digital signal outputted by the analog to digital conversion circuit.

4. The control device according to claim 1, wherein the m-bit digital signal is a most significant bit (MSB) of the n-bit digital signal.

5. The control device according to claim 2, wherein the predetermined m-bit digital signal is the first m-bit digital signal converted by the analog to digital conversion circuit in the detecting mode.

6. A signal processing method for a touch panel, wherein the is touch panel comprises a plurality of X-directional sensing lines and a plurality of Y-directional sensing lines, the X-directional sensing lines and the Y-directional sensing lines are arranged in a staggered manner, and the signal processing method comprising the following steps:
selecting sensing lines to be measured from the X-directional sensing lines and the Y-directional sensing lines;
determining a threshold value and a bit number m to be measured;
converting voltages of the sensing lines to be measured in accordance with the m-bit and outputting an m-bit digital signal;
detecting the converted m-bit digital signal and a difference between the m-bit digital signal and a predetermined m-bit digital signal, when the converted m-bit digital signal and the predetermined m-bit digital signal have the same value to accumulate a counting value; and
converting voltages of the sensing lines to be measured to an n-bit digital signal when the counting value is greater than or equal to the threshold value, wherein n>m.

7. The signal processing method according to claim 7, wherein the n-bit digital signal represents the touching condition of the sensing line to be measured.

8. The signal processing method according to claim 7, wherein the bit number m to be measured is a most significant bit (MSB) of the n-bit digital signal.

9. The signal processing method according to claim 7, wherein the predetermined m-bit digital signal is the first m-bit digital signal to be converted.
